(19) United States
(12) Patent Application Publication
(10) Pub. No.: US 2003/0145239 A1
(43) Pub. Date: Jul. 31, 2003

(54) Dynamically adjustable cache size based on application behavior to save power

(76) Inventors: Wayne D. Kever, Ft. Collins, CO (US); Eric S. Fetzer, Longmont, CO (US)

Correspondence Address: HEWLETT-PACKARD COMPANY, Intellectual Property Administration, P.O. Box 272400, Fort Collins, CO, 80527-2400, US

(21) Appl. No.: 10/062,231

(22) Filed: Jan. 31, 2002

(51) Int. Cl. G06F 1/26

(52) U.S. Cl. 713/300

(57) ABSTRACT

A circuit for reducing power in an on-chip cache memory on a microprocessor chip is implemented by dynamically controlling power applied to individual memory sections. Individual sections of memory are isolated from a fixed power supply by inserting one or more switches between GND and a negative connection of an individual memory section or by inserting one or more switches between VDD and a positive connection of an individual memory section. If a memory section is not accessed for a defined time, a PMU (Performance Monitor Unit) detects it and the power to that section is switched off, saving power. In addition, a software application may send information to the PMU to select the amount of cache memory needed for the particular software application.

### FIELD OF THE INVENTION

This invention relates generally to electronic circuits. More particularly, this invention relates to reducing average power in cache memory arrays.

### BACKGROUND OF THE INVENTION

As more electronic circuits are included on a single die, the power dissipated by a single die continues to increase. In order to keep the temperature of a single IC (integrated circuit) at a reasonable temperature, many techniques have been used to cool the IC. For example, elaborate cooling fins have been attached to the substrate of ICs. Also, fans have been positioned near a group of IC's to cool them. In some cases, liquids have been used to reduce the heat produced by ICs. These solutions can be costly and may require a great deal of space, where space is at a premium. If the power on ICs can be reduced while still achieving higher levels of integration, the cost and area of devices that use ICs may be reduced.

As the size of microprocessors continues to grow, the size of the cache memory that is often included on a microprocessor chip may grow as well. In some applications, cache memory may utilize more than half the physical size of a microprocessor. As cache memory grows so does power consumption.

On-chip cache memory on a microprocessor is usually divided into groups: one group stores data and another group stores addresses. Within each of these groups, cache is further grouped according to how fast information may be accessed. A first group, usually called L1, may consist of a small amount of memory, for example 16 k bytes. L1 usually has very fast access times. A second group, usually called L2, may consist of a larger amount of memory, for example 256 k bytes, however the access time of L2 is slower than L1. A third group, usually called L3, may have even a larger amount of memory than L2, for example 4M bytes. The memory contained in L3 has slower access times than L1 and L2.

A performance monitor unit (PMU) on a microprocessor monitors, among other things, “misses” that occur in cache memory. A “miss” occurs when the CPU asks for information from a section of the cache and the information isn't there. If a miss occurs in a L1 section of cache, the CPU may look in a L2 section of cache. If a miss occurs in the L2 section, the CPU may look in L3.

Generally, L1 cache is accessed more often than L2 and L3 cache, and L2 is accessed more often than L3. Because L3 is accessed less frequently than L1 or L2, there may be times when sections of L3 cache are not accessed.

The sections of L3 memory that are not being accessed may be monitored using a PMU. After identifying memory sections that are not being accessed, the power to these sections may be shut off. In this way, power may be directed to sections of L3 memory that are currently active and power may be shut-off from sections that are not accessed.

Sections of L3 cache memory may be turned off based on the amount of on-chip cache memory a software application needs. For example, transaction-processing applications often require larger amounts of cache memory as compared to engineering applications. Because the amount of on-chip cache memory of a microprocessor is fixed, power may be saved by turning off sections of L3 cache that aren't needed for certain applications and turning on more sections of L3 cache when other applications require it.

When a software application is compiled, a signal may be sent from the software application to the PMU to indicate how much L3 cache memory the application may need. The PMU then turns on the appropriate amount of cache memory needed for that application.

While a software application is running, the application may also send a signal to the PMU to indicate how much L3 cache memory the application needs at that time.

The following description of an apparatus and method for applying power to individual sections of L3 cache fills a need in the art to reduce power in ICs and computer systems while maintaining performance requirements.

### SUMMARY OF THE INVENTION

An embodiment of the invention provides a circuit and a method for controlling power in individual memory arrays of a cache memory. Individual arrays of memory are isolated from a fixed power supply by inserting one or more switches between GND and the negative connection of an individual memory section or between VDD and the positive connection of an individual memory section. These switches are controlled by a performance monitor unit (PMU). If a memory array is not accessed for specific length of time, the PMU will detect it and shut off the power to that memory section. If an inactive memory array is accessed, the PMU will detect the accesses and provide power to the inactive memory array. A software application may also provide information to a PMU concerning how much cache memory is needed. This invention fills a need to reduce overall power on a microprocessor chip.

Other aspects and advantages of the present invention will become apparent from the following detailed description, taken in conjunction with the accompanying drawing, illustrating by way of example the principles of the invention.

### BRIEF DESCRIPTION OF THE DRAWINGS

FIG. 1 is a schematic drawing of cache memory elements connected to VDD through switches controlled by a PMU.

FIG. 2 is a schematic drawing of cache memory elements connected to GND through switches controlled by a PMU.

### DETAILED DESCRIPTION OF THE PREFERRED EMBODIMENT

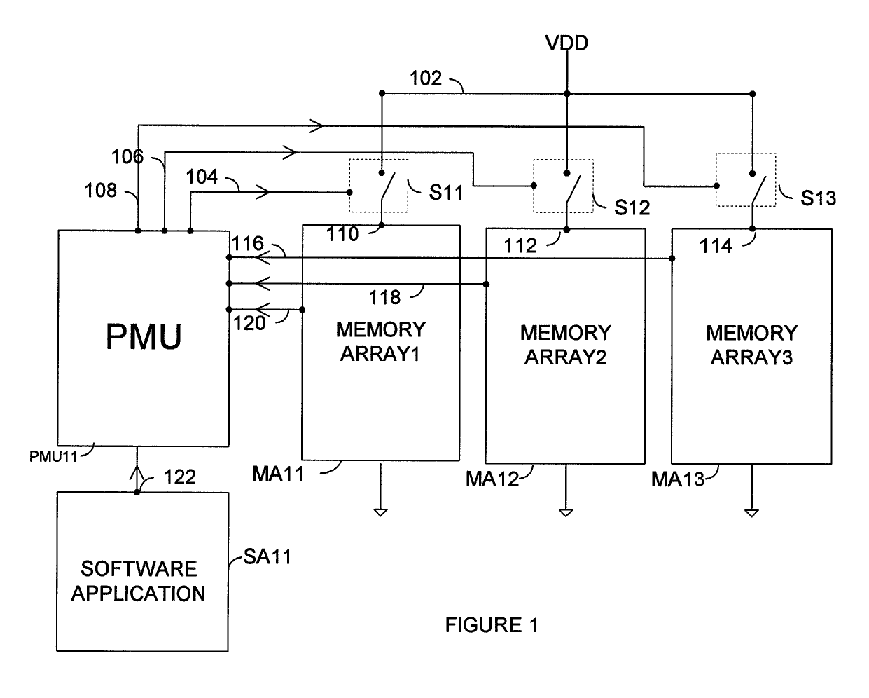

FIG. 1 shows three cache memory arrays, MA11, MA12, and MA13 connected to a positive power supply, 102, VDD through three switches, S11, S12, and S13 at nodes 110, 112, and 114 respectively. A PMU, PMU11, is connected to memory arrays, MA11, MA12, and MA13 at nodes 116, 118, and 120 respectively and to a software application, SA11 at node 122. Three outputs from PMU, PMU11, 104, 106, and 108 control switches S11, S12, and S13 respectively.

If, for example, PMU, PMU11, detects that memory array MA11 has not been accessed for a certain length of time, the CPU will flush the data, and PMU11 will send a signal that opens switch S11. With switch S11 open, power can not be supplied to memory array MA11. If after sometime, memory array MA11 has a number of cache “misses”, PMU11 will send a signal that closes switch S11 supplying power to MA11. In this manner PMU11 may turn power on or off to any memory array based on how often the array is utilized.

A software application, SA11, may also send a signal to PMU11. The software application determines how much cache memory it may need and sends that information to PMU11. PMU11 will either add or remove cache arrays to meet the memory needs of the particular software application by switching on-chip cache memory in or out. For example if an application does not require the full on-chip cache memory, it will send a signal to PMU11 to switch off the appropriate number of cache memory arrays. The software application may send the proper signal to PMU11 while the software application compiles or when the software application is running.

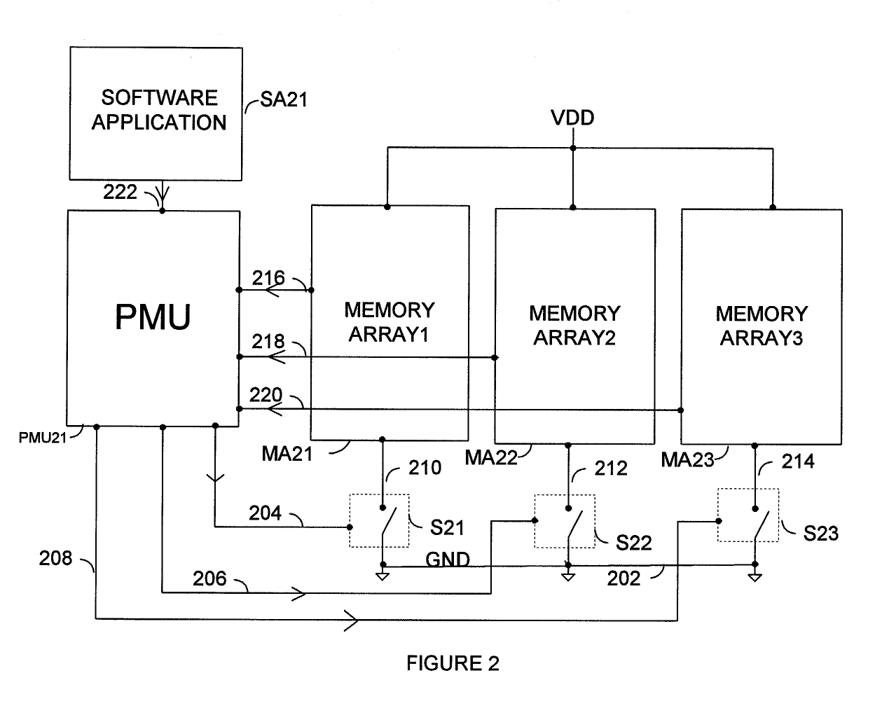

FIG. 2 shows three cache memory arrays, MA21, MA22, and MA23 connected to a negative power supply, 202, GND through three switches, S21, S22, and S23 at nodes 210, 212, and 214 respectively. A PMU, PMU21, is connected to memory arrays, MA21, MA22, and MA23 at nodes 216, 218, and 220 respectively and to software application, SA21 at node 222. Three outputs from PMU, PMU21, 204, 206, and 208 control switches S21, S22, and S23 respectively.

If, for example, PMU, PMU21, detects that memory array MA21 has not been accessed for a certain length of time, PMU21 will send a signal that opens switch S21. With switch S21 open, power can not be supplied to memory array MA21. If after sometime, memory array MA21 has a number of cache “misses,” PMU11 will send a signal that closes switch S21 supplying power to MA21. In this manner MPU21 may turn power on or off to any memory array based on how often the array is utilized.

A software application, SA21, may also send a signal to PMU21. The software application determines how much cache memory it may need and sends that information to PMU21. PMU21 will either add or remove cache arrays to meet the memory needs of the particular software application by switching on-chip cache memory in or out. For example if an application does not require the full on-chip cache memory, it will send a signal to PMU21 to switch off the appropriate number of cache memory arrays. The software application may send the proper signal to PMU21 while the software application compiles or when the software application is running.

Switches may be implemented with MOSFETs (Metal Oxide Semiconductor Field Effect Transistor), bipolar transistors, or any other type of semiconductor transistor.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1) A circuit for applying power to an on-chip cache memory array comprising:
a switch in series with a power supply and said on-chip cache memory array;
a PMU electrically connected to said on-chip cache memory array;
a software application electrically connected to said PMU;
wherein said switch may be opened or closed by said PMU.

2) The circuit as in claim 1 wherein said switching device is connected between a negative terminal of said on-chip cache memory array and GND of said power supply.

3) The circuit as in claim 2 wherein said switching device is a MOSFET.

4) The circuit as in claim 2 wherein said switching device is a bipolar transistor.

5) The circuit as in claim 1 wherein said switching device is connected between a positive terminal of said on-chip cache memory array and VDD of said power supply.

6) The circuit as in claim 5 wherein said switching device is a MOSFET.

7) The circuit as in claim 5 wherein said switching device is a bipolar transistor.

8) A circuit for applying power to an on-chip cache memory array comprising:
a switch in series with a power supply and said on-chip cache memory array;
a PMU electrically connected to said on-chip cache memory array;
wherein said switch may be opened or closed by said PMU.

9) The circuit as in claim 8 wherein said switching device is connected between a negative terminal of said on-chip cache memory array and GND of said power supply.

10) The circuit as in claim 9 wherein said switching device is a MOSFET.

11) The circuit as in claim 9 wherein said switching device is a bipolar transistor.

12) The circuit as in claim 8 wherein said switching device is connected between a positive terminal of said on-chip cache memory array and VDD of said power supply.

13) The circuit as in claim 12 wherein said switching device is a MOSFET.

14) The circuit as in claim 12 wherein said switching device is a bipolar transistor.

15) A circuit for applying power to an on-chip cache memory array comprising:
a switch in series with a power supply and said on-chip cache memory array;
a software application electrically connected to a PMU;
wherein said switch may be opened or closed by said PMU.

16) The circuit as in claim 15 wherein said switching device is connected between a negative terminal of said on-chip cache memory array and GND of said power supply.

17) The circuit as in claim 16 wherein said switching device is a MOSFET.

18) The circuit as in claim 16 wherein said switching device is a bipolar transistor.

19) The circuit as in claim 15 wherein said switching device is connected between a positive terminal of said on-chip cache memory array and VDD of said power supply.

20) The circuit as in claim 19 wherein said switching device is a MOSFET.

21) The circuit as in claim 19 wherein said switching device is a bipolar transistor.

22) A method for applying power to a on-chip cache memory array comprising:
electrically connecting a switch between a power supply and said on-chip cache memory array;
electrically connecting a PMU to said on-chip cache memory array;
electrically connecting a software application to said PMU;
wherein said switch may be opened or closed by said PMU.

23) The method as in claim 22 wherein said switching device is connected between a negative terminal of said on-chip cache memory array and GND of said power supply array.

24) The method as in claim 23 wherein said switching device is a MOSFET.

25) The method as in claim 23 wherein said switching device is a bipolar transistor.

26) The method as in claim 22 wherein said switching device is connected between a positive terminal of said on-chip cache memory array and VDD of said power supply.

27) The method as in claim 26 wherein said switching device is a MOSFET.

28) The method as in claim 26 wherein said switching device is a bipolar transistor.

29) A method for applying power to an on-chip cache memory array comprising:
electrically connecting a switch between a power supply and said on-chip cache memory array;
electrically connecting a PMU to said on-chip cache memory array;
wherein said switch may be opened or closed by said PMU.

30) The method as in claim 29 wherein said switching device is connected between a negative terminal of said on-chip cache memory array and GND of said power supply array.

31) The method as in claim 30 wherein said switching device is a MOSFET.

32) The method as in claim 30 wherein said switching device is a bipolar transistor.

33) The method as in claim 29 wherein said switching device is connected between a positive terminal of said on-chip cache memory array and VDD of said power supply.

34) The method as in claim 33 wherein said switching device is a MOSFET.

35) The method as in claim 33 wherein said switching device is a bipolar transistor.

36) A method for applying power to a cache memory array comprising:
electrically connecting a switch between a power supply and said on-chip cache memory array;
electrically connecting a software application to a PMU;
wherein said switch may be opened or closed by said PMU.

37) The method as in claim 36 wherein said switching device is connected between a negative terminal of said on-chip cache memory array and GND of said power supply array.

38) The method as in claim 37 wherein said switching device is a MOSFET.

39) The method as in claim 37 wherein said switching device is a bipolar transistor.

40) The method as in claim 36 wherein said switching device is connected between a positive terminal of said on-chip cache memory array and VDD of said power supply.

41) The method as in claim 40 wherein said switching device is a MOSFET.

42) The method as in claim 40 wherein said switching device is a bipolar transistor.
